(19) United States
(12) Patent Application Publication
(10) Pub. No.: US 2008/0001569 A1
(43) Pub. Date: Jan. 3, 2008

(54) Motor driving apparatus

(75) Inventor: Takumi Ito, Yokohama-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 11/812,531

(22) Filed: Jun. 19, 2007

(30) Foreign Application Priority Data
Jun. 19, 2006 (JP) 2006-169423

(51) Int. Cl. G05B 1/06

(52) U.S. Cl. 318/652; 318/638

(57) ABSTRACT

A motor driving apparatus includes a control circuit configured to control an electric current flowing in a coil for driving a motor for driving a galvanometer mirror. The control circuit includes a PWM signal generating circuit configured to generate a PWM signal having a fundamental frequency equal to or greater than 50 kHz and equal to or less than 1 MHz and an output transistor element configured to perform switching driving of the electric current output based on the PWM signal; and a pulse width of the PWM signal is controlled by a control signal being input to the PWM signal generating circuit.

### BACKGROUND OF THE INVENTION

1. Field of the Invention

The present invention relates to a motor driving apparatus configured to drive a motor by using a PWM (Pulse Width Modulation) signal of a high frequency equal to or greater than 50 kHz. More specifically, the present invention relates to a motor driving apparatus of a motor for driving a galvanometer mirror.

2. Description of the Related Art

Conventionally, in a laser apparatus where the direction of a laser light is changed by a galvanometer mirror, the laser light is converged by a lens or the like so as to be irradiated on an object, and the laser light is scanned by rotating the galvanometer mirror so that a process such as marking for the object is performed.

In the above-mentioned laser apparatus, there is a need to control a driving motor for the galvanometer mirror with high precision and at high speed by a servo motor. Accordingly, an analog linear amplifier using a servo circuit based on an analog signal is applied to the motor driving apparatus. See, for example, Japanese Laid-Open Patent Application Publication No. 2004-136351.

On the other hand, in the field of, for example, air conditioning system, efficiency of motor driving, reduction of electric power consumption by reducing losses, miniaturization of the apparatus and the like are frequently required rather than the precision or speed of motor driving.

Because of this, in such a field, a PWM (Pulse Width Modulation) method having good electric power efficiency is frequently applied to the motor driving apparatus. A switching frequency is approximately 10 kHz or 15 kHz. See, for example, Japanese Laid-Open Patent Application Publication No. 2004-212004.

However, in the structure described in Japanese Laid-Open Patent Application Publication No. 2004-136351, since a linear amplifier is used, electric power loss and heat generation due to a partial pressure load in a transistor for signal control are large. Therefore, it may not be possible to realize high power.

Furthermore, as the size of the galvanometer mirror is larger, the measurement of the motor driving apparatus is larger and costs increase.

In addition, in the structure described in Japanese Laid-Open Patent Application Publication No. 2004-212004, since the switching frequency is approximately 10 kHz or 15 kHz in the PWM method, the PWM method can correspond to general equipment such as an air conditioning system or a compressor. However, this PWM method cannot be applied to a use requiring high precision or high response, such as a driving motor of the galvanometer mirror or an X-Y stage used for a manufacturing apparatus or inspection apparatus of a semiconductor device, a liquid crystal device, or the like.

### SUMMARY OF THE INVENTION

Accordingly, embodiments of the present invention may provide a novel and useful motor driving apparatus solving one or more of the problems discussed above.

More specifically, the embodiments of the present invention may provide a motor driving apparatus wherein a switching frequency of a PWM method can be equal to or greater than 50 kHz; a response speed required for a galvanometer mirror driving motor or a stage driving motor used for a manufacturing apparatus or inspection apparatus of a semiconductor device, a liquid crystal, or the like can be obtained; and an extremely lower loss than that of the linear amplifier type can be achieved.

One aspect of the present invention may be to provide a motor driving apparatus including a control circuit configured to control an electric current flowing in a coil for driving a motor for driving a galvanometer mirror, wherein the control circuit includes a PWM signal generating circuit configured to generate a PWM signal having a fundamental frequency equal to or greater than 50 kHz and equal to or less than 1 MHz and an output transistor element configured to perform switching driving of the electric current output based on the PWM signal; and a pulse width of the PWM signal is controlled by a control signal being input to the PWM signal generating circuit.

Another aspect of the present invention may be to provide a motor driving apparatus including a control circuit configured to control an electric current flown in a coil for driving a motor, wherein the control circuit includes a PWM signal generating circuit configured to generate a PWM signal having a fundamental frequency equal to or greater than 50 kHz and equal to or less than 1 MHz and an output transistor element configured to perform switching driving of the electric current output based on the PWM signal; and a pulse width of the PWM signal is controlled by a control signal being input to the PWM signal generating circuit.

Other objects, features, and advantages of the present invention will be come more apparent from the following detailed description when read in conjunction with the accompanying drawings.

### BRIEF DESCRIPTION OF THE DRAWINGS

FIG. 1 is a block diagram of a motor driving apparatus of a first example of the present invention;

FIG. 2 is a table for explaining a fundamental frequency of a PWM signal of the first example of the present invention (more specifically, FIG. 2(a) is a table showing frequency response required to a motor driving apparatus for driving a galvanometer mirror, and FIG. 2(b) is a comparison table showing carriers and response frequencies of electric current control bands of a conventional PWM method, a linear type, and a high speed PWM method of the first example of the present invention.);

FIG. 3 is a circuit diagram showing an entire structure of a circuit of a motor driving apparatus of the first example of the present invention;

FIG. 4 is a graph for explaining a PWM method;

FIG. 5 is a view showing dead time;

FIG. 6 is a view for explaining a conventional linear amplifier type motor driving apparatus for the galvanometer mirror (more specifically, FIG. 6(a) is a structural view for a linear amplifier type circuit, and FIG. 6(b) is a view showing an example of an equivalent circuit of a single phase);

FIG. 7 is a circuit diagram of a modified example of the motor driving apparatus shown in FIG. 3 through FIG. 5 of the first example of the present invention;

FIG. 8 is a view showing a modified example of the motor driving apparatus shown in FIG. 7 of the first example of the present invention (FIG. 8A is a circuit diagram of the motor driving apparatus of this modified example, FIG. 8B is a graph showing a voltage waveform of a PWM signal, and FIG. 8C is a circuit diagram of a modified example of the circuit diagram shown in FIG. 8A);

FIG. 9 is a circuit diagram of a motor driving apparatus of a second example of the present invention;

FIG. 10 is a circuit diagram for explaining operations of the motor driving apparatus of the second example of the present invention (more specifically, FIG. 10(a) is a circuit diagram showing an example of a self-oscillating PWM method circuit and FIG. 10(b) is a graph showing the relationship between a delta wave and a PWM signal waveform); and

FIG. 11 is a circuit diagram showing a modified example of the motor driving apparatus shown in FIG. 9 of the second example of the present invention (FIG. 11A is a circuit diagram showing a modified example of the motor driving apparatus of the second example of the present invention and FIG. 11B is a circuit diagram showing a modified example of the motor driving apparatus shown in FIG. 11A).

### DETAILED DESCRIPTION OF THE PREFERRED EMBODIMENTS

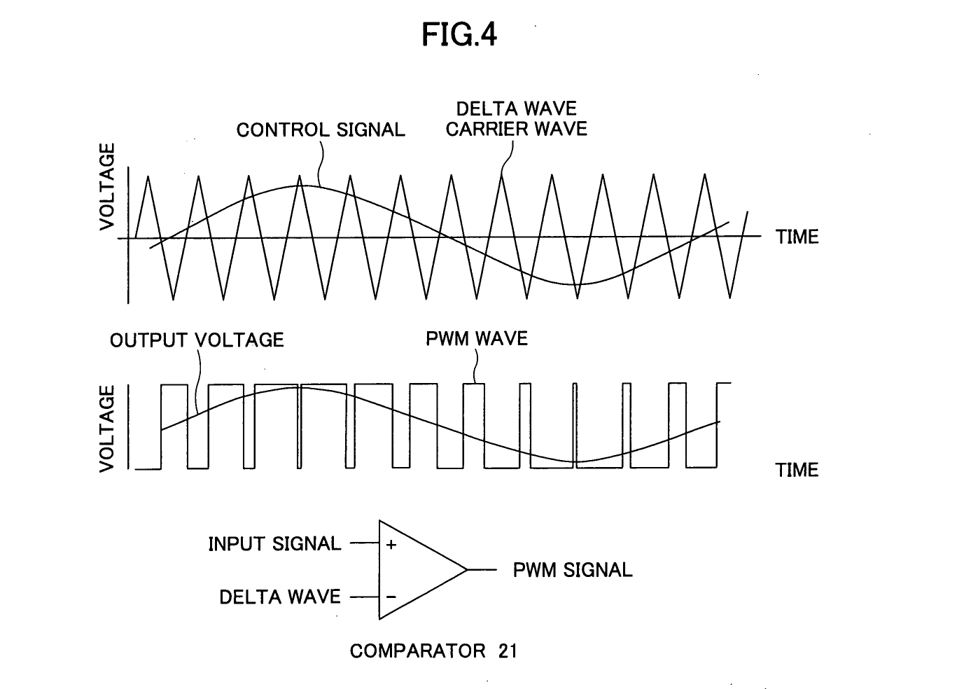

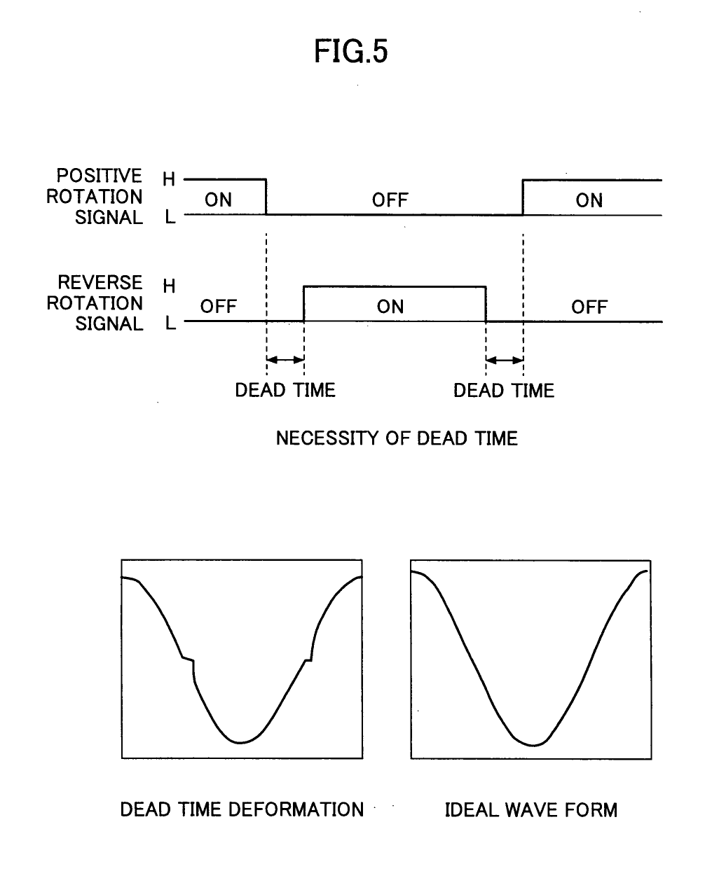

A description is given below, with reference to the FIG. 4 through FIG. 24 of embodiments of the present invention.

### FIRST EXAMPLE

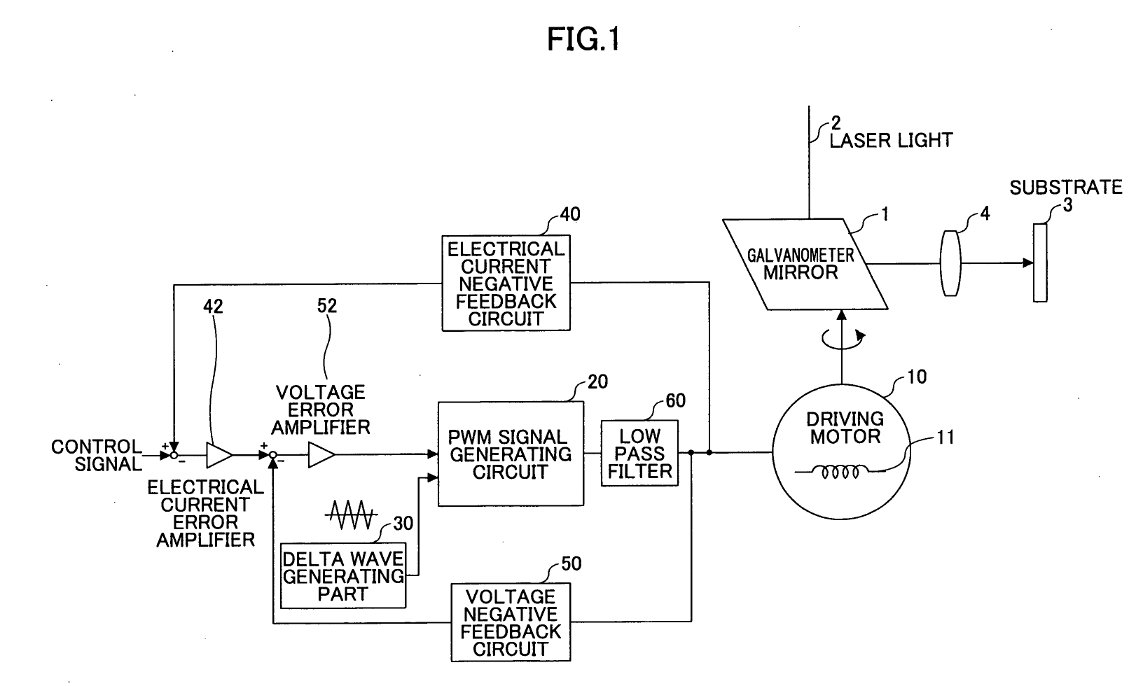

FIG. 1 is a block diagram of a motor driving apparatus of a first example of the present invention.

The motor driving apparatus includes a galvanometer mirror driving motor 10 and a PWM signal generating circuit 20. The galvanometer mirror driving motor 10 rotationally drives a galvanometer mirror 1. The PWM signal generating circuit 20 supplies a PWM signal to the galvanometer mirror driving motor 10.

The motor driving apparatus may include, if necessary, either of or an element of combination of a delta wave generating part 30, an electric current negative feed back circuit 40, a voltage negative feed back circuit 50, and a low pass filter 60.

In addition, the electric current negative feed back circuit 40 may have an electric current error amplifier 42. The voltage negative feed back circuit 50 may have a voltage error amplifier.

The galvanometer mirror 1 is a control object of a laser apparatus where the first example of the present invention is applied. Operations of the galvanometer mirror 1 are controlled by the galvanometer mirror driving motor 10 which is a control object of the motor driving apparatus of the first example of the present invention.

The galvanometer mirror 1 reflects the laser light 2 so that the direction of the laser light 2 is changed. The angle of the laser light 2 is rotated so that position control is made and thereby the laser light condensed by a convergent lens 4 is irradiated on a desirable position for scanning.

Since the irradiation of the laser light on a substrate 3 is made at a high speed such as 2000 points per second, the positioning speed of 2000 times per second, namely response equal to or greater than 2 kHz is required for positioning the galvanometer mirror 1. Therefore, it is required for the galvanometer mirror driving motor 10 and the motor driving apparatus for driving control to have response for position controlling at 2 kHz or more.

The galvanometer mirror driving motor 10 is one kind of a VCM (Voice Coil Motor) and does not have a commutator such as a rotating type motor which is generally used. The galvanometer mirror driving motor 10 is a motor which minutely vibrates and by which highly response operations can be performed with high precision.

Next, operations of the motor driving apparatus of the first example of the present invention are discussed.

First, a control signal for controlling driving of the motor 10 is input to the PWM signal generating circuit 20. In the PWM signal generating circuit 20, while the PWM signal for driving the motor 10 is generated, the fundamental frequency of the PWM signal is equal to or greater than 50 kHz and less than 1 MHz. The fundamental frequency is defined by the frequency of a carrier generated by an oscillating circuit.

The pulse width of the PWM signal is defined by a control signal being input to the PWM signal generating circuit 20. The control signal is PWM modulated by a separate oscillation method or a self-oscillating method so that the PWM signal is generated.

In the separate oscillation method, a control signal and a delta wave generated by the delta wave generating part 30 provided outside are input to the PWM signal generating circuit 20. In the PWM signal generating circuit 20, the control signal and the delta wave are compared by a comparator. As a result of this, amplitude information is digitalized so that the PWM signal is generated.

On the other hand, in the self-oscillating method, oscillating operations are done in the PWM signal generating circuit 20 so that the PWM signal is generated. The PWM signal generated in the PWM signal generating circuit 20 is sent to the driving coil 11 of the motor 10 so that the motor 10 is driven. Motor driving control is implemented based on the PWM signal in the motor 10.

Here, the PWM signal for driving the motor 10 may be fed back by the electric current negative feed back circuit 40 so as to be reflected in a control signal being input to the PWM signal generating circuit 20. In other words, an electric current flowing in the driving coil 11 of the motor 10 may be supplied to the control signal so as to be reflected in a control target electric current value.

In addition, an electric current of the control signal may be compensated by the electric current error amplifier 42. Since it is preferable to control the torque of the motor 10 in the motor driving apparatus of the first example of the present invention, control of an output torque may be implemented by controlling the electric current flowing in the driving coil 11 proportional to the torque.

In addition, a voltage negative feed back circuit 50 may be provided in the motor driving apparatus. The voltage negative feed back circuit 50 may include a voltage error amplifier 52 configured to compensate the voltage error and reduce a waveform deformation of the PWM output signal.

The motor 10 can be controlled with high precision by providing the voltage negative feed back circuit 50. If the electric current negative feed back circuit 40 is regarded as a major loop, the voltage negative feed back circuit 50 comprises an inside feed back loop as a minor loop.

In other words, a voltage proportional to the PWM signal is detected. Feed back control for removing the waveform deformation is provided inside the electric current negative feed back circuit 40 so as to perform cascade control. As a result of this, torque control with higher response speed and precision can be achieved.

In addition, in the motor driving apparatus, a low pass filter 60 is provided at an output side of the PWM signal in order to remove a high frequency element. The low pass filter 60 includes a coil and a condenser and removes the high frequency element of the PWM signal to ground.

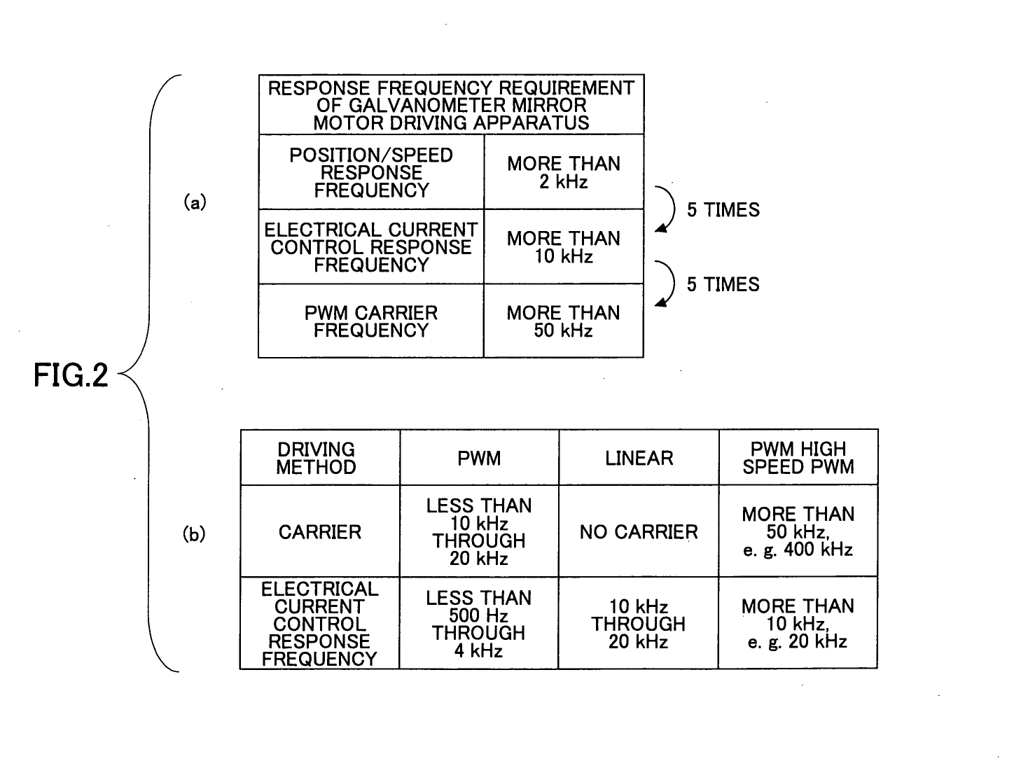

Next, a fundamental frequency of the PWM signal of the motor driving apparatus of the first example of the present invention is discussed with reference to FIG. 2.

FIG. 2(a) is a table showing frequency response required to the galvanometer mirror driving motor 10.

As discussed above, there may be a case where the response frequency for the position/speed control required for the motor driving apparatus is equal to or greater than 2 kHz. In order to perform the position/speed control equal to or greater than 2 kHz, in an electric current control system of the motor driving apparatus, a response frequency five times 2 kHz is needed. In other words, a response frequency equal to or greater than 10 kHz is necessary.

In addition, in order to drive the electric current control system having a frequency equal to or greater than 10 KHz by the PWM method, it is necessary to make the carrier for generating the PWM signal have a carrier frequency equal to or greater than 50 kHz which is 5 times 10 kHz or more.

FIG. 2(b) is a comparison table showing carriers and response frequencies of electric current control bands of a conventional PWM method applied to a conventional motor driving apparatus for a general industry such as an air conditioning system, a linear type applied to a conventional motor driving apparatus of a motor for driving a galvanometer mirror, and a high speed PWM method of the first example of the present invention.

In the conventional PWM method, the carrier frequency is less than 10 kHz through 20 kHz and the response frequency in the electric current control band is less than 500 Hz through 4 kHz. Since 10 kHz or more as minimum is required as a response frequency in the electric current control band of the motor driving apparatus of the galvanometer mirror driving motor 10, there is a lack of the response frequency in the conventional PWM method.

On the other hand, in the linear type, the carrier is not used and a relatively high speed response frequency of 10 kHz through 20 kHz is obtained in the electric current band. This satisfies the requirement as the motor driving apparatus for the motor for driving the galvanometer mirror.

However, as discussed above, in the case of the linear type, loss of electric power and heat generation are large. As the size of the galvanometer mirror 1 is larger, the size of the motor driving apparatus 10 is larger.

In the PWM method of the first example of the present invention, the carrier frequency is equal to or greater than 50 kHz and the response frequency in the electric current control band is equal to or greater than 10 kHz. This number indicates a minimum number of the carrier frequency.

In the PWM method of the motor driving apparatus of the first example of the present invention, the fundamental frequency equal to or greater than 50 kHz and equal to or less than 1 MHz can be used. Preferably, the fundamental frequency equal to or greater than 150 kHz and equal to or less than 700 kHz can be used. More preferably, the fundamental frequency equal to or greater than 300 kHz and equal to or less than 500 kHz can be used. Most preferably, the fundamental frequency of 400 kHz can be used.

As a result of the use of the carrier of the fundamental frequency, response frequency equal to or greater than 10 kHz as minimum can be realized in the electric current control band. In addition, in a case where the carrier whose fundamental frequency is 400 kHz is used, it is possible to realize the response frequency equal to or greater than 20 kHz.

This is a level higher than that of the linear type. Therefore, it is possible to respond to the request for high speed response and realize low loss with the PWM method and miniaturization.

In addition, in the PWM method using the carrier whose fundamental frequency is 400 kHz, dead time can be made extremely short and equal to or less than 100 ns. Here, the dead time is set in order to avoid the circumstance where both signals of positive rotation and reverse rotation are turned ON due to the delay of the time of a switching signal.

As a result of this, it is possible to make the dead time deformation of the conventional PWM method short.

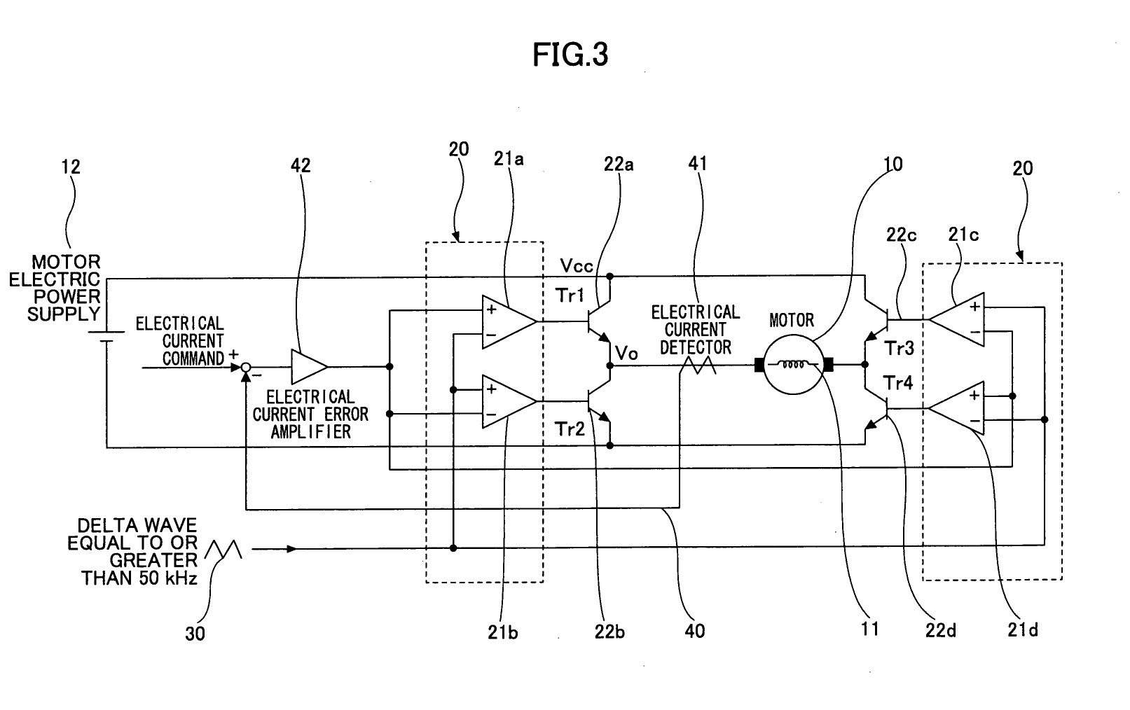

Next, a circuit structure of the motor driving apparatus of the first example of the present invention is discussed with reference to FIG. 3 through FIG. 5. In FIG. 3 through FIG. 5, parts that are the same as the parts shown in FIG. 1 are given the same reference numerals, and explanation thereof is omitted.

FIG. 3 is a circuit diagram showing an entire structure of a circuit of the motor driving apparatus of the first example of the present invention.

The motor driving apparatus includes a motor electric power source 12, an error amplifier 42, a delta wave generating part 30, comparators 21a through 21d, output transistor elements 22a through 22d, an electric current negative feed back circuit 40, an electric current detector 41, and the motor 10. A portion including the comparators 21 forms the PWM signal generating circuit.

Next, operations of the circuit shown in FIG. 3 are discussed.

The motor electric power source 12 is used for driving the motor driving apparatus. A terminal voltage of the motor electric power supply 12 is Vcc.

A command control signal that is an object value of the motor driving apparatus is input and sent to the error amplifier 42. The error amplifier 42 performs compensation based on the output electric current detected by the electric current detector 41 and the input command control signal so as to amplify and output a compensated control signal.

The output control signal is sent to the comparators 21a through 21d. The delta wave of a frequency equal to or greater than 50 kHz is input from the delta wave generating part 30 to each of the comparators 21a through 21d. This delta wave is a carrier wave called a carrier of the PWM method and the fundamental frequency of the PWM signal is defined by this carrier frequency.

As long as a part generating the delta wave equal to or greater than 50 kHz is provided, any part can be used as the delta wave generating part 30. A general oscillating circuit may be used. For example, a crystal resonator circuit, a CD oscillating circuit, or an LC back coupling oscillating circuit may be used. Alternatively, a delta wave oscillator, where two operational amplifiers are provided and one is operated as a Schmitt circuit and another is operated as an integrating circuit, may be used.

It is preferable that the oscillating frequency of the delta wave be, for example, equal to or greater than 50 kHz and equal to or less than 1 MHz. It is more preferable that the oscillating frequency of the delta wave be equal to or greater than 150 kHz and equal to or less than 700 kHz. It is further more preferable that the oscillating frequency of the delta wave be equal to or greater than 300 kHz and equal to or less than 500 kHz. It is most preferable that the oscillating frequency of the delta wave be approximately 400 kHz.

FIG. 4 is a graph for explaining the PWM method.

Voltage comparison of the input control signal and the delta wave are made by the comparator 21. A part where the voltage of the control signal is higher than the voltage of the delta wave is switched to 1 and a part where the voltage of the control signal is lower than the voltage of the delta wave is switched to 0, so that the signal is digitalized. The pulse width of the PWM signal is controlled based on which is larger or smaller between the control signal and the delta wave.

In other words, that the pulse width of the PWM signal is large means that the voltage of the control signal is high. That the pulse width of the PWM signal is small means that the voltage of the control signal is low.

The fundamental frequency of the generated PWM signal is defined based on the carrier frequency and is equal to or greater than 50 kHz and equal to or less than 1 MHz. The pulse width is controlled by a control signal being input to the comparator 21 forming the PWM signal generating circuit 20.

Referring back to FIG. 3, the output transistor elements 22a through 22d perform switching driving of output based on the PWM signal generated by the PWM signal generating circuit 20. The output transistor elements 22a through 22d form a so-called H bridge circuit and a switching circuit for switching positive rotation and reverse rotation of the motor 10.

In other words, for example, in a case where the motor 10 is positively rotated, the output transistor elements 22a and 22d are turned ON and the output transistor elements 22b and 22c are turned OFF so that the electric current flows from left to right of the driving coil 11 of the motor 10.

On the other hand, in a case where the motor 10 is reverse-rotated, the output transistor elements 22b and 22c are turned ON and the output transistor elements 22a and 22d are turned OFF so that the electric current flows from right to left of the driving coil 11 of the motor 10.

The above-mentioned switching driving is performed, based on the control signal from the error amplifier 42, by the PWM signal being output from the PWM signal generating circuit including the comparators 21a through 21d. In the meantime, the above-mentioned “positive rotation” and “negative rotation” are relative and therefore either rotation may be called “positive rotation”.

By switching driving the output transistor element 21 by the PWM signal, the electric power loss is drastically reduced.

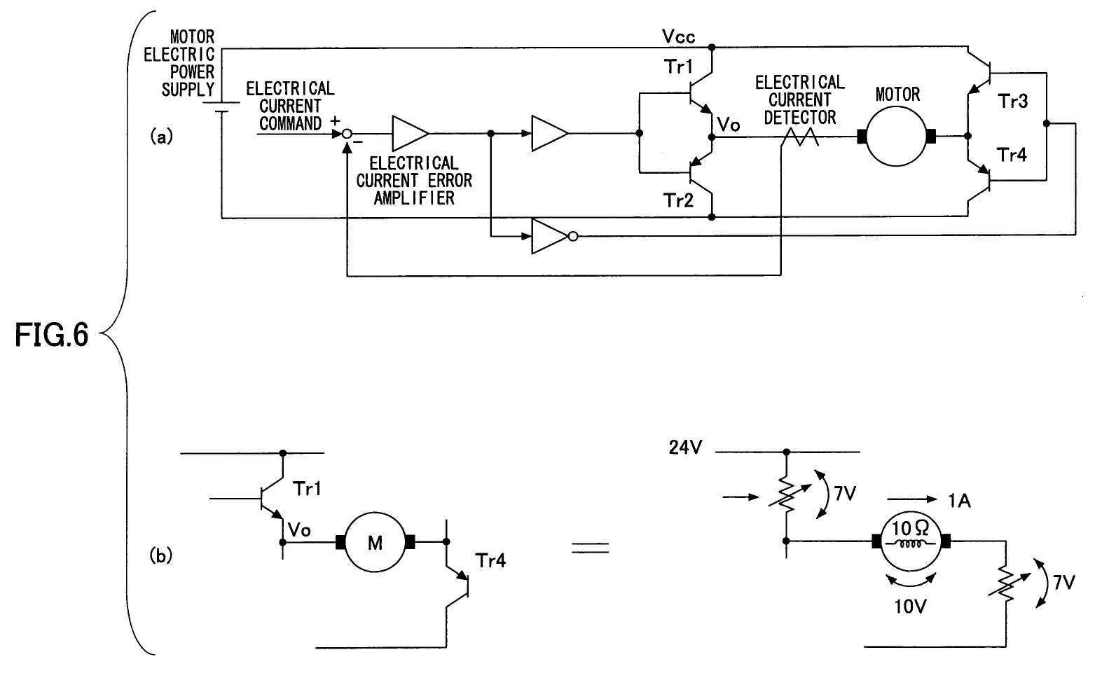

FIG. 6(a) is a structural view for a linear amplifier type circuit and FIG. 6(b) is a view showing an example of an equivalent circuit of a single phase.

Referring to FIG. 6(a), it is assumed that Vcc is 24 V, Tr1 and Tr4 are turned ON, Tr2 and Tr3 are turned OFF, impedance of the driving coil of the motor is 10Ω, and 1 Å of electric current is flown. The transistor and the terminal of the motor are shown in a left drawing of FIG. 6(b).

Since the transistor is not operated at saturation, this can be regarded as variable resistance. Therefore the left drawing of FIG. 6(b) is equivalent to a right drawing of FIG. 6(b).

In this case, while the voltage applied to the motor is 10 V, voltages of 7 V are applied to Tr1 and Tr4, which are replaced with the variable resistances, so that a large electric power loss such as approximately 7 W is generated and heat generation becomes large.

In the structure shown in FIG. 6(a), if the transistor is not operated at saturation, electric power is always consumed due to the intermediate transistor load. However, in the structure shown in FIG. 3, electric power is consumed in the transistor only when the pulse is turned ON. Therefore, only loss due to the pulse occurs and the electric power loss is drastically reduced.

In addition, in FIG. 3, as the output transistor element 21, not only a normal transistor but also various kinds of transistors such as MOSFET (Metal Oxide Semiconductor Field Effect Transistor) or IGBT (Insulated Gate Bipolar Transistor) may be used.

Especially, high speed switching driving can be realized by the MOSFET. For example, the MOSFET is proper for driving at 400 kHz switching frequency. Because of this, the response frequency of the electric current control system can be equal to or greater than 20 kHz.

Thus, it is possible to satisfy positioning/speed determining response frequency equal to or greater than 2 kHz required for positioning the galvanometer mirror. In addition, by making the fundamental frequency of the PWM signal have high speed, it is possible to make dead time necessary for the PWM method extremely short.

FIG. 5 is a view showing dead time.

In a case where switching is performed by a semiconductor such as a transistor, even if the OFF signal is provided, an ON state continues just after this. Therefore, the dead time is provided as a waiting time in order to prevent a short circuit. However, the wave form may be deformed as shown in FIG. 5.

Due to the dead time deformation, operations based on the command of the control signal may not be done. Therefore, it is preferable to set the dead time to a short time.

In this example, since the fundamental frequency of the PWM signal is made to have a high speed, this dead time can be shortened. Therefore, switching driving having less delay time and high response can be realized.

For example, in a case where the carrier frequency of the delta wave is 400 kHz, the dead time can be set to be extremely short time, equal to or less than 100 ns. Since the dead time in the conventional PWM method may be approximately 1 through 10 μsec, the dead time in this example is drastically reduced.

Referring back to FIG. 3, the electric current detector 41 detects electric current flowing in the driving coil 11 of the motor 10 and performs feed back control by the electric current negative feed back circuit 40. Since the driving electric current of the motor 10 is proportional to the torque of the motor 10, torque control of the motor 10 is done by the driving electric current of the motor 10.

In this example, the response frequency of the electric current control system can be equal to or greater than 10 kHz, preferably equal to or greater than 20 kHz. Regardless of kinds or types, a normal electric current sensor may be used as the electric current sensor configured to detect the electric current flown in the driving coil 11 of the motor 10.

As discussed above, the controller of the control system may use the error amplifier 42. By the electric current negative feed back circuit 40 forming the electric current control system, it is possible to perform positioning control/control for determining speed of the motor 10 precisely.

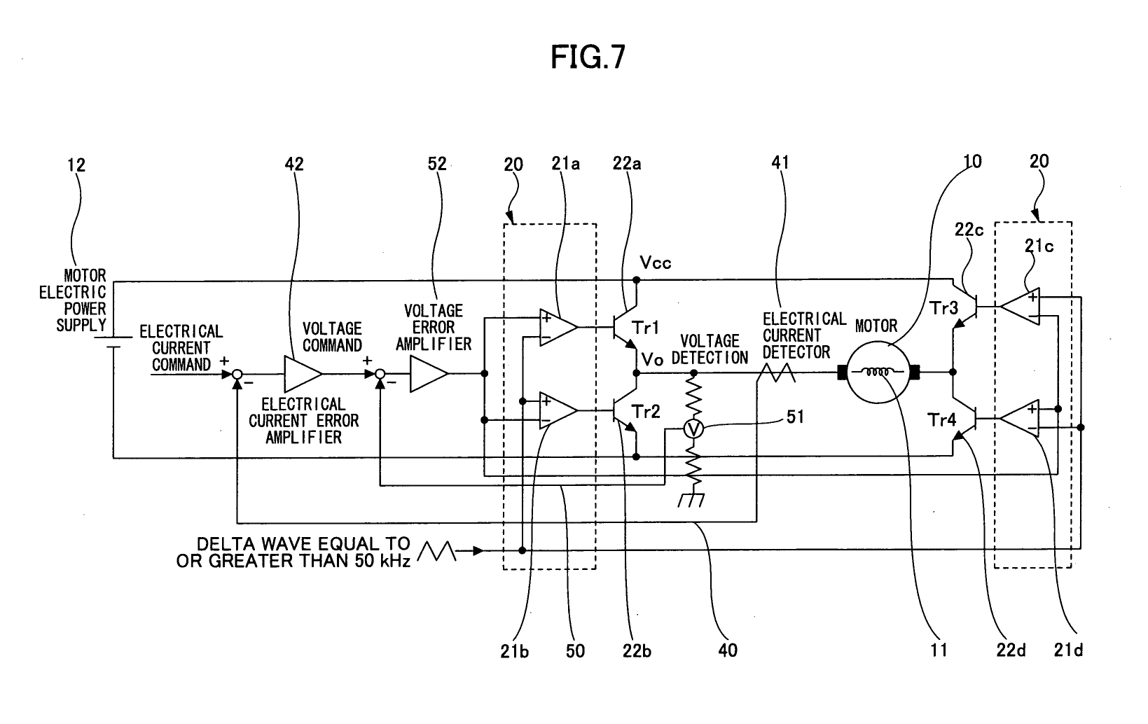

FIG. 7 is a circuit diagram of a modified example of the motor driving apparatus shown in FIG. 3 through FIG. 5 of the first example of the present invention.

The motor driving apparatus shown in FIG. 7 is different from the motor driving apparatus shown in FIG. 5 in that the voltage negative feed back circuit 50 is added to the motor driving apparatus shown in FIG. 5. In FIG. 7, parts that are the same as the parts shown in FIG. 5 are given the same reference numerals, and explanation thereof is omitted.

The motor driving apparatus shown in FIG. 7 includes the motor electric power source 12, the error amplifier 42, the voltage error amplifier 52, the delta wave generating part 30, the comparators 21a through 21d, the output transistor elements 22a through 22d, a voltage detector 51, a voltage negative feed back circuit 50, the electric current negative feed back circuit 40, the electric current detector 41, and the motor 10. A portion including the comparators 21 forms the PWM signal generating circuit.

Elements added in FIG. 7 as compared to FIG. 3 are the voltage negative feed back circuit 50 and the voltage detector 51 and the voltage error amplifier 52 related to the voltage negative feed back circuit 50. This structure is discussed below.

The voltage negative feed back circuit 50 detects a voltage proportional to the output voltage of the motor driving apparatus and performs a fixed control so that this voltage waveform is stable. Therefore, by this control loop, the voltage waveform is properly formed so that higher precision torque control can be achieved.

The voltage negative feed back circuit 50 depends on the electric current negative feed back circuit 40. In other words, the voltage negative feed back circuit 50 forming the minor loop or slave loop is provided inside the electric current negative feed back circuit 40 as a major loop or master loop. That is, a cascade control having a double control loop is properly formed.

Therefore, the voltage negative feed back circuit 50 requires a short response time or small delay compared to the control loop of the electric current negative feed back circuit 40. In addition, it is effective for only the disturbance generated in the voltage negative feed back circuit 50. Therefore, the voltage wave form of the signal being output from the output transistor element 22 is properly formed.

More specifically, a voltage is detected from a standard point proportional to the output voltage by the voltage detector and fed back to the control electric current being output from the electric current error amplifier 42 so as to be added. Its signal is input to the voltage error amplifier 52.

The voltage error amplifier 52 compensates so that the voltage waveform of the signal being output from the output transistor element 22 is constant. Since the process after this is the same as that discussed with reference to FIG. 3, explanation thereof is omitted.

According to this example, it is possible to make the motor driving apparatus have high precision in addition to low electric power loss, low heat generation and high response frequency.

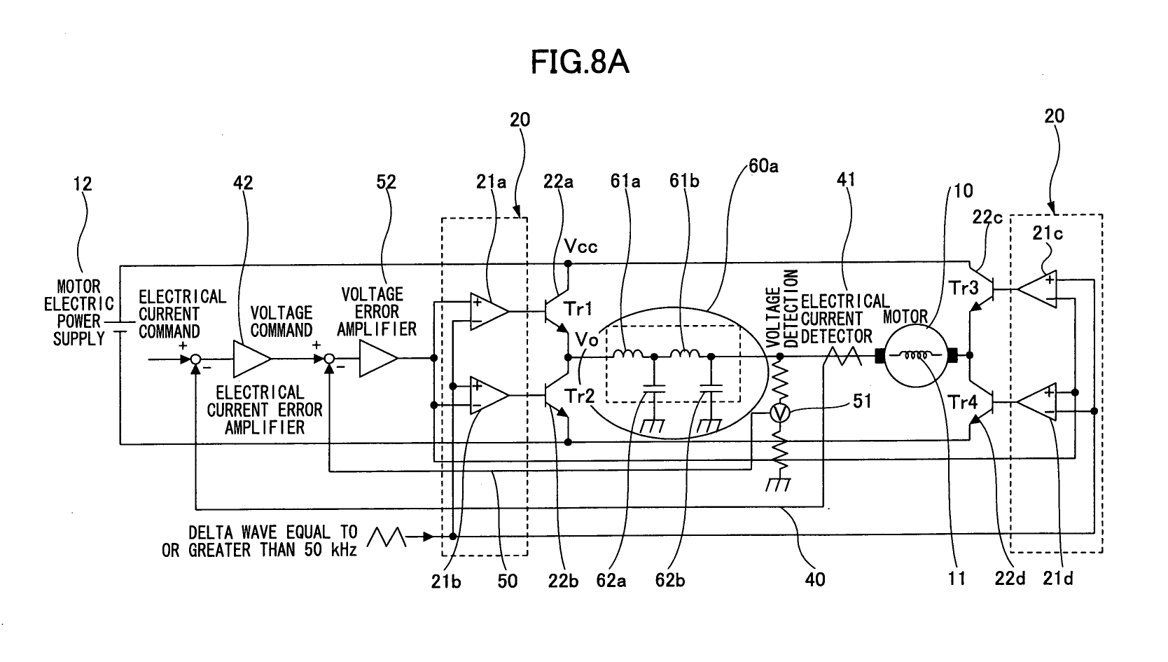

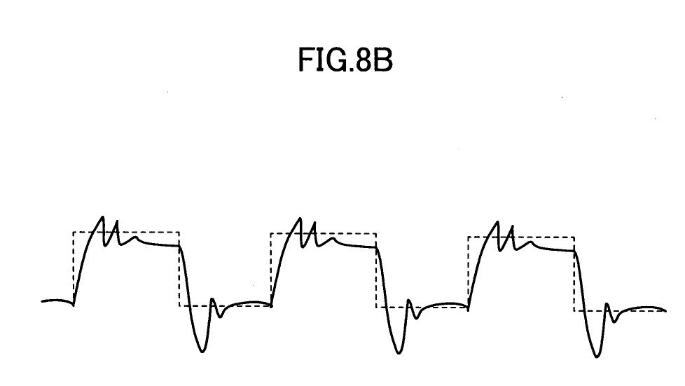

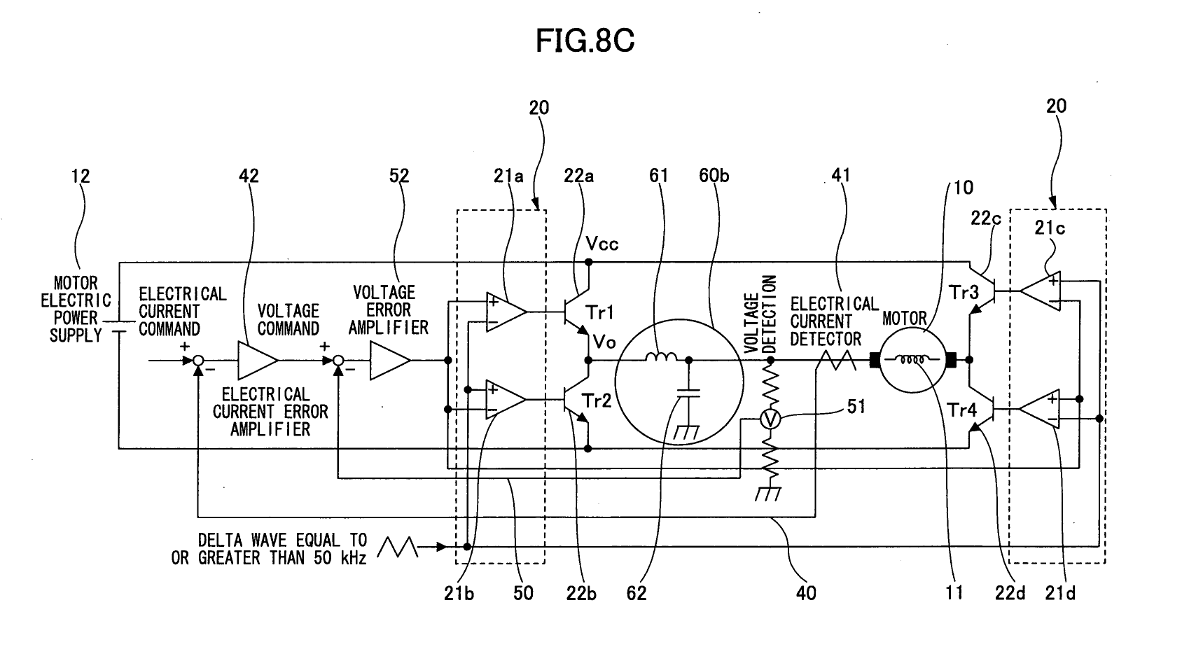

FIG. 8 is a view showing a modified example of the motor driving apparatus shown in FIG. 7 of the first example of the present invention.

FIG. 8A is a circuit diagram of the motor driving apparatus of this modified example. This circuit diagram is different from the circuit diagram shown in FIG. 7 in that the low pass filter is added in the example shown in FIG. 8A. In FIG. 8, parts that are the same as the parts shown in FIG. 7 are given the same reference numerals, and explanation thereof is omitted.

As shown in FIG. 8A, the low pass filter 60a includes the coils 61a and 61b and the condensers 62a and 62b.

The low pass filter 60a passes the frequency equal to or less than a center frequency of the signal being output from the output transistor element 22 does not pass/removed the high frequency element. In other words, the alternating-current element of the high frequency passes through the condensers 62a and 62b so as to discharge to ground.

FIG. 8B is a graph showing a voltage waveform of n output signal being output from the output transistor 22.

As shown in FIG. 8B, a booting part of a pulse vibrates minutely and a high frequency element appears. The low pass filter 60a removes such a high frequency element and cuts the high frequency. The low pass filter 60a together with the voltage negative feedback circuit 50 makes the voltage waveform of the output signal stable so that control with higher precision can be performed.

FIG. 8C is a circuit diagram of a modified example of the circuit diagram shown in FIG. 8A.

Only the structure of the low pass filter 60b shown in FIG. 8C is different from the low pass filter 60a shown in FIG. 8A. The low pass filter 60b includes a single coil 61 and a single condenser 62 so that a single step LC is formed. As long as sufficient effect is achieved, a single step LC low pass filter may be used. It is preferable to provide a simple structure.

Thus, depending on the balance of the entire circuit structure and a desirable object, the structure of the low pass filter 60 may be properly deformed.

### SECOND EXAMPLE

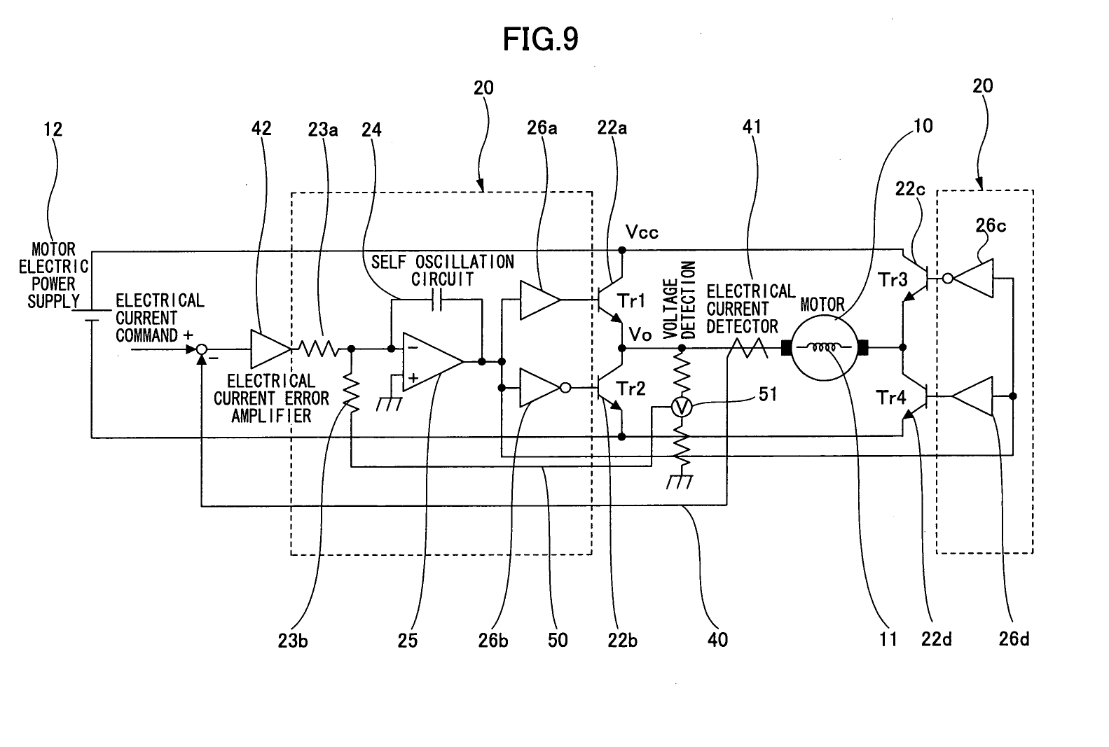

FIG. 9 is a circuit diagram of a motor driving apparatus of a second example of the present invention. The motor driving apparatus of the second example is a self-oscillating PWM apparatus.

In other words, while the delta wave oscillating part 30 for generating the delta wave is provided outside the PWM signal generating circuit 20 and the PWM signal is obtained by comparing the delta wave and the carrier in the motor driving apparatus shown in FIG. 3, FIG. 7, and FIG. 8 of the first example of the present invention, the oscillating operations are done in the PWM signal generating circuit 20 in the motor driving apparatus of the second example of the present invention.

The motor driving apparatus includes the motor electric power source 12, the error amplifier 42, the resistances 23a and 23b, the condenser 24, an operational amplifier 25, amplifiers 26a and 26d, reverse rotation amplifiers 26b and 26c, output transistor elements 22a through 22d, the voltage detector 51, the electric current detector 41, and the motor 10. As negative feed back parts, both the electric current detector 41 and the voltage negative feed back circuit 50 are provided. In the second example, parts that are the same as the parts discussed in the first example are given the same reference numerals, and explanation thereof is omitted.

In the self-oscillating type PWM method of the second example of the present invention, depending on the voltage of the input signal, the pulse width is changed. Because of this, the PWM signal is generated and the switching driving of the output transistor elements 22a through 22d is operated.

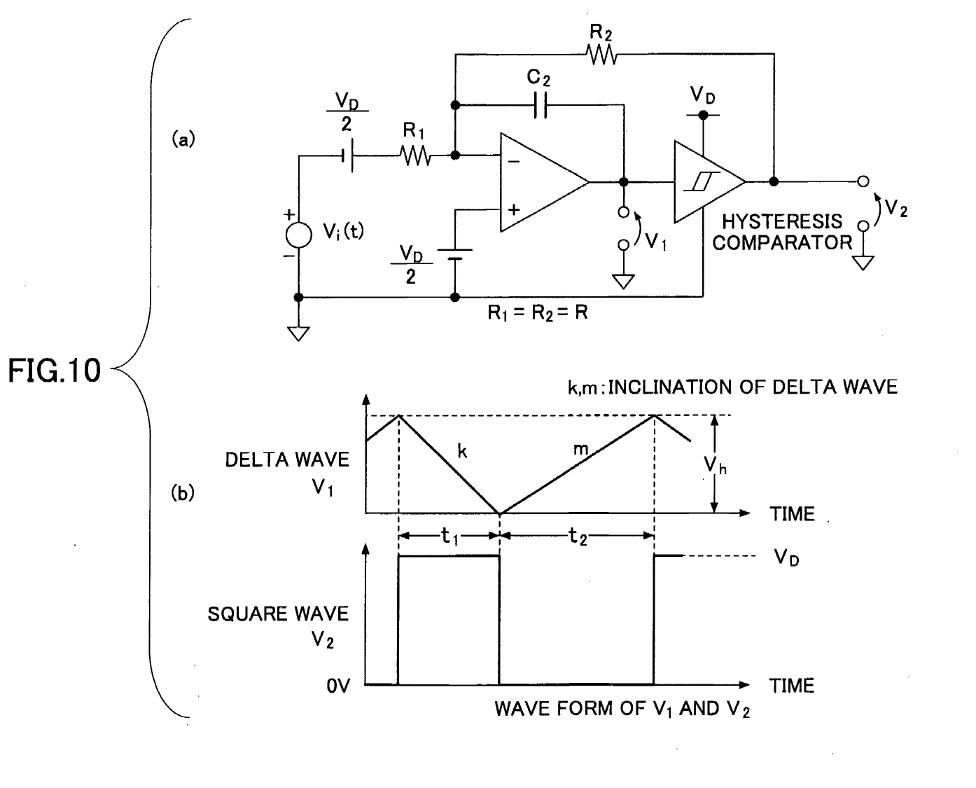

The operations are discussed with reference to FIG. 10.

FIG. 10 is a circuit diagram for explaining operations of the motor driving apparatus of the second example of the present invention (more specifically, FIG. 10(a) is a circuit diagram showing an example of a self-oscillating PWM circuit. FIG. 10(b) is a graph showing the relationship between a delta wave and a PWM signal waveform.

In the circuit shown in FIG. 10(a), when the amplitude of the input signal is zero, the circuit works as an oscillating circuit of the delta wave so that the delta wave is oscillated.

Here, if an input signal Vᵢ(t) is input, an inclination of the delta wave is changed depending on Vᵢ(t) and the pulse width is changed. When the oscillating frequency is sufficiently higher than the frequency of the input signal, the on duty Dₒₙ(t) of the PWM signal output is expressed as follows.

Dₒₙ(t)=0.5−Vᵢ(t)/V_{D}

Although this calculation is well known, if the oscillating frequency is sufficiently higher than the frequency of the input signal, change of Vᵢ(t) for a single period of the delta wave is extremely small. Therefore, Vᵢ(t) can be regarded as a direct voltage. Therefore, the following formulas hold.

|k|={V_{D}/2+Vᵢ(t)}/RC₂=Vₕ/t₁

|m|={V_{D}/2+Vᵢ(t)}/t₂=Vₕ/t₂

Based on this, the on duty Dₒₙ(t) of the PWM signal output is calculated as follows.

Dₒₙ(t)=t₁/(t₁+t₂)=(Vₕ/t₂)/(Vₕ/t₂+Vₕ/t₁)={V_{D}/2−Vᵢ(t)}/V_{D}=0.5−Vᵢ(t)/V_{D}

Therefore, the on duty of the PWM signal is defined based on the voltage change of the input signal.

Since functions of the circuit discussed with reference to FIG. 10 are made in the example shown in FIG. 9, the PWM signal is output as the signal output from the operational amplifier 25.

Based on the PWM signal, when the amplifiers 26a and 26d are turned ON, the reverse rotation amplifiers 26b and 26c are turned OFF. When the amplifiers 26a and 26d are turned OFF, the reverse rotation amplifiers 26b and 26c are turned ON. Therefore, the output transistors 22a through 22d are switched corresponding to this so that the motor 10 is controlled.

According to this example, it is not necessary to independently provide the delta wave oscillating part 30 in the motor driving apparatus. Depending on the size of the control signal to be input, the PWM signal is output so that the motor 10 can be controlled at a high speed and relatively stable motor driving can be realized with a simple circuit structure.

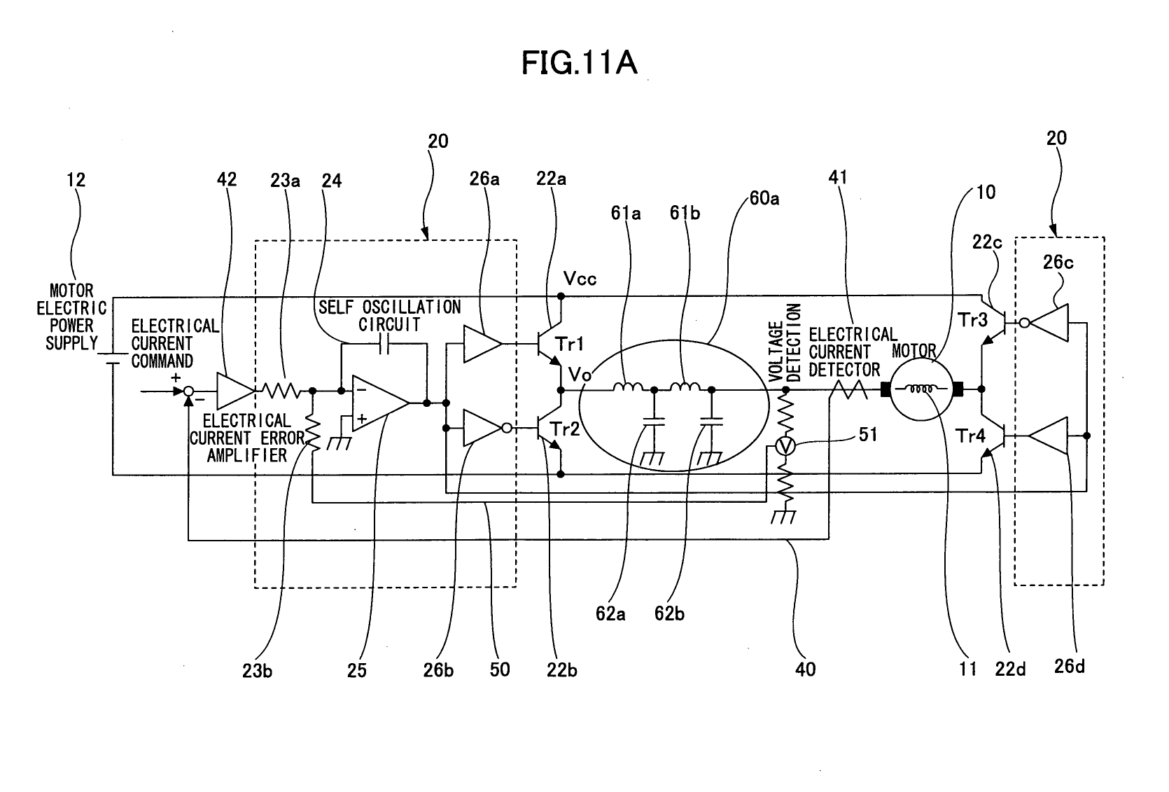

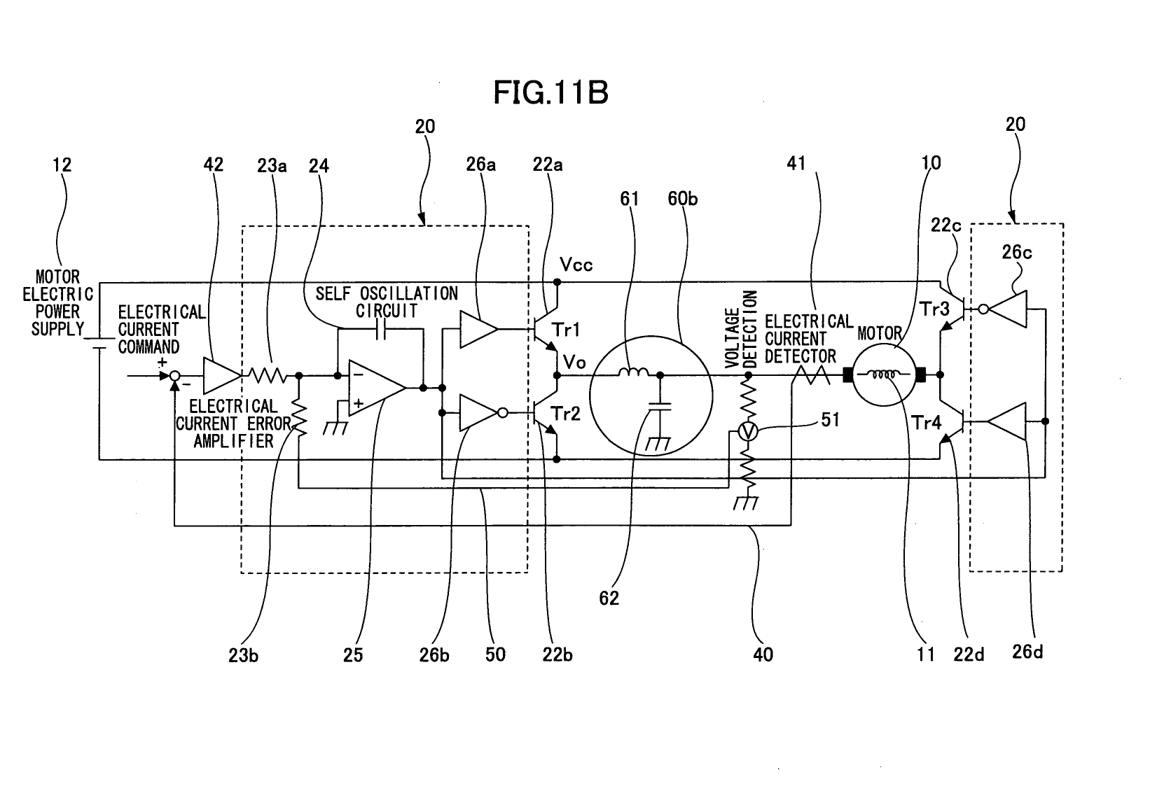

FIG. 11 is a circuit diagram showing a modified example of the motor driving apparatus shown in FIG. 9 of the second example of the present invention. FIG. 11A is a circuit diagram showing a modified example of the motor driving apparatus of the second example of the present invention. The example shown in FIG. 11A is different from the example shown in FIG. 9 in that the low pass filter 60a is added.

As well as the low pass filter 60a discussed with reference to FIG. 8A, the low pass filter includes the coils 61a and 61b and the condensers 62a and 62b.

By passing the signal being output from the output transistor element 22 through the low pass filter 69a in this example as well as the example discussed with reference to FIG. 8B, the high frequency which is an excessive noise can be removed and cut so that the voltage waveform of the output signal can be properly formed. As a result of this, it is possible to control motor driving with higher precision.

FIG. 11B is a circuit diagram showing a modified example of the motor driving apparatus having another type low pass filter 60b different from that shown in FIG. 11A.

The low pass filter 60b includes a pair of the coil 61 and the condenser 62. The low pass filter 60b, as well as the low pass filter 60a shown in FIG. 11A, removes and cuts a high frequency element. Depending on the circuit structure and use, the low pass filter 60a shown in FIG. 11A or the low pass filter 60b shown in FIG. 11B may be properly selected.

Thus, according to the above-discussed examples of the present invention, it is possible to provide a motor driving apparatus including a control circuit configured to control an electric current flowing in a coil for driving a motor for driving a galvanometer mirror, wherein the control circuit includes a PWM signal generating circuit configured to generate a PWM signal having a fundamental frequency equal to or greater than 50 kHz and equal to or less than 1 MHz and an output transistor element configured to perform switching driving of the electric current output based on the PWM signal; and a pulse width of the PWM signal is controlled by a control signal being input to the PWM signal generating circuit.

It is possible to obtain the response required for the motor for driving the galvanometer mirror, and low loss, miniaturization and low cost can be realized.

The PWM signal generating circuit may generate the PWM signal based on comparison between a delta wave being input from an outside and the control signal.

The PWM signal generating circuit can generate the PWM signal based on the delta wave generated by the stable oscillating circuit so that stable driving can be realized.

The motor driving apparatus may further include an electric current negative feed back circuit configured to supply an electric current detected value flowing in the coil for driving the motor to the control signal; and a voltage negative feed back circuit configured to correct the waveform of the PWM signal based on a voltage proportional to an output voltage of the motor driving apparatus.

It is possible to perform the feed back control of the electric current control system and provide the wave form of the PWM signal.

The PWM signal generating circuit may generate the PWM signal by a self-oscillating circuit controlling the pulse width based on a size of the control signal.

While the structure of the PWM signal generating circuit can be simplified, stable driving can be performed.

A low-pass filter may be provided at an electric current output side of the output transistor element configured to perform switching driving; and the low-pass filter may pass a frequency equal to or less than a center frequency of the output electric current.

It is possible to remove the high frequency element of the waveform of the PWM signal and wave form can be properly formed.

According to the above-discussed examples of the present invention, it is also possible to provide a motor driving apparatus, including a control circuit configured to control an electric current flown in a coil for driving a motor, wherein the control circuit includes a PWM signal generating circuit configured to generate a PWM signal having a fundamental frequency equal to or greater than 50 kHz and equal to or less than 1 MHz and an output transistor element configured to perform switching driving of the electric current output based on the PWM signal; and a pulse width of the PWM signal is controlled by a control signal being input to the PWM signal generating circuit.

It is possible obtain the response required for the motor for driving the galvanometer mirror, a stage driving motor used for a manufacturing apparatus or inspection apparatus of a semiconductor device, a liquid crystal device, or the like, and low loss, miniaturization and low cost can be realized.

As discussed above, according to the above-discussed examples of the present invention, it is possible to provide a motor driving apparatus whereby motor driving requiring high precision and high speed response can be realized while low loss, miniaturization and low cost can be realized by the PWM method.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

In the above-discussed examples, a case where the motor driving apparatus is applied to the galvanometer mirror driving motor 10 used for the laser apparatus, is mainly discussed. However, the present invention can be used for a system using an actuator such as a linear motor, a VCM (Voice Coil Motor) or a rotating motor, where the system requires high response and high precision.

For example, the present invention can be applied to an X-Y stage movably mounting an object of an inspection apparatus or manufacturing apparatus of a semiconductor device or liquid crystal. In a case where the present invention is applied to the X-Y stage, a high speed PWM method of the present invention and the linear amplifier method may be combined. Advantages of both methods are combined so that it is possible to correspond to requirements of a manufacturing line requiring high precision and high through put.

In the case of the X-Y stage, the motor driving apparatus of the present invention can be applied to a linear motor which is a driving part of the X-Y stage. In a case of a Z axial stage, the motor driving apparatus of the present invention can be applied to a VCM used for Z axial driving. By using the driving apparatus of the present invention, it is possible to realize the stage apparatus with high precision, high response and low loss.

In the meantime, a precision apparatus requiring high precision and high response such as a stage apparatus or a laser apparatus is generally vulnerable to heat. Therefore, response and precision may be changed due to heat generated by the driving part. The motor driving apparatus of the examples of the present invention runs on low power loss and generates little heat. Therefore, even if the motor driving apparatus of the examples of the present invention is applied to a precision apparatus, influence of heat can be prevented and therefore the present invention can be applied to the precision apparatus.

In addition, the motor driving apparatus of the examples of the present invention can be applied to a driving source of a bonding apparatus for wire bonding or the like.

This patent application is based on Japanese Priority Patent Application No. 2006-169423 filed on Jun. 19, 2006, the entire contents of which are hereby incorporated by reference.

What is claimed is:

1. A motor driving apparatus, comprising:
a control circuit configured to control an electric current flowing in a coil for driving a motor for driving a galvanometer mirror,
wherein the control circuit includes a PWM signal generating circuit configured to generate a PWM signal having a fundamental frequency equal to or greater than 50 kHz and equal to or less than 1 MHz and an output transistor element configured to perform switching driving of the electric current output based on the PWM signal; and
a pulse width of the PWM signal is controlled by a control signal being input to the PWM signal generating circuit.

2. The motor driving apparatus as claimed in claim 1,
wherein the PWM signal generating circuit generates the PWM signal based on comparison between a delta wave being input from an outside and the control signal.

3. The motor driving apparatus as claimed in claim 1, further comprising:
an electric current negative feed back circuit configured to supply an electric current detected value flowing in the coil for driving the motor to the control signal; and
a voltage negative feed back circuit configured to correct the waveform of the PWM signal based on a voltage proportional to an output voltage of the motor driving apparatus.

4. The motor driving apparatus as claimed in claim 1,
wherein the PWM signal generating circuit generates the PWM signal by a self-oscillating circuit controlling the pulse width based on a size of the control signal.

5. The motor driving apparatus as claimed in claim 1,
wherein a low-pass filter is provided at an electric current output side of the output transistor element configured to perform switching driving; and
the low-pass filter passes a frequency equal to or less than a center frequency of the output electric current.

6. A motor driving apparatus, comprising:
a control circuit configured to control an electric current flown in a coil for driving a motor,
wherein the control circuit includes a PWM signal generating circuit configured to generate a PWM signal having a fundamental frequency equal to or greater than 50 kHz and equal to or less than 1 MHz and an output transistor element configured to perform switching driving of the electric current output based on the PWM signal; and
a pulse width of the PWM signal is controlled by a control signal being input to the PWM signal generating circuit.

7. The motor driving apparatus as claimed in claim 6, further comprising:
an electric current negative feed back circuit configured to supply an electric current detected value flowing in the coil for driving the motor to the control signal; and
a voltage negative feed back circuit configured to correct the waveform of the PWM signal based on a voltage proportional to an output voltage of the motor driving apparatus.

8. The motor driving apparatus as claimed in claim 7,
wherein the PWM signal generating circuit generates the PWM signal based on a comparison between a delta wave being input from an outside and the control signal.

9. The motor driving apparatus as claimed in claim 7,
wherein the PWM signal generating circuit generates the PWM signal by a self-oscillating circuit controlling the pulse width based on a size of the control signal.

10. The motor driving apparatus as claimed in claim 7,
wherein a low-pass filter is provided at an electric current output side of the output transistor element configured to perform switching driving; and
the low-pass filter passes a frequency equal to or less than a center frequency of the output electric current.
